(19) United States
(12) Patent Application Publication
(10) Pub. No.: US 2023/0232144 A1
(43) Pub. Date: Jul. 20, 2023

(54) Exposed Copper Area for Port Electrostatic Discharge Protection

(71) Applicant: Google LLC, Mountain View, CA (US)

(72) Inventors: Ketan Shringarpure, Santa Clara, CA (US); Warwick Ka Kui Wong, Palo Alto, CA (US); Chi Kin Benjamin Leung, Sunnyvale, CA (US); Yao Ding, San Jose, CA (US); Jingyu Huang, Santa Clara, CA (US); Jae Lee, Palo Alto, CA (US)

(21) Appl. No.: 17/685,924

(22) Filed: Mar. 3, 2022

Related U.S. Application Data
(60) Provisional application No. 63/300,466, filed on Jan. 18, 2022.

(51) Int. Cl. H04R 1/08; H04R 1/04; H02H 9/04

(52) U.S. Cl. CPC H04R 1/083; H04R 1/04; H02H 9/046; H04R 2499/11

(57) ABSTRACT

The disclosure generally relates to a conductive layer having one or more protrusions configured to attract an electrostatic discharge (“ESD”) arc. The device may be any device, such as a smartphone, tablet, earbuds, etc. The device may include a microphone and, therefore, may include a microphone opening. The conductive layer may include a conductive opening axially aligned with the microphone opening and one or more protrusions extending radially inwards towards the center of the conductive opening.

### CROSS-REFERENCE TO RELATED APPLICATIONS

The present application claims the benefit of the filing date of U.S. Provisional Patent Application No. 63/300,466 filed Jan. 18, 2022, the disclosure of which is hereby incorporated herein by reference.

### BACKGROUND

Devices may have housings made of plastic. Some devices, such as smartphones, AR/VR goggles, earbuds, etc., have a microphone within the plastic housing. The microphone may be mounted on a printed circuit board or flexible circuit board. Generally, the microphone is connected to the circuit board by connection pads which in turn connect to copper (or another such metal) traces. The connection pads and traces form electrical pathways through which the microphone may receive and/or output signals to the other components of the device. The housing may include an opening where the microphone is positioned to provide an unimpeded path between audio waves and the microphone. However, this opening may expose portions of the electrical pathways on the side of the printed circuit board facing the opening in the housing. The exposed copper may attract electrostatic discharge arcs. The electrostatic discharge arcs may come from outside the housing, from a user that is using the device, or another charged object or person, etc. The electrostatic discharge arc may strike close to the microphone and, therefore, cause damage to the microphone.

### BRIEF SUMMARY

The technology generally relates to a device including a conductive layer having one or more protrusions that attract electrostatic discharge (“ESD”). The device may be any device, such as a smartphone, tablet, earbuds, AR/VR headset, etc. The device may include one or more components, such as a microphone, within a housing of the device. The housing may be a non-conductive material. There may be a component opening in the housing, such as an opening for the microphone. The conductive layer may be located between the housing and the microphone to protect the microphone from an ESD strike. The conductive layer may include one or more protrusions that extend radially inwards towards the center of the opening. In some examples, each of the protrusions may include a vertex. The ESD arc may be attracted to the vertex of the protrusion, protecting the microphone from being damaged by the ESD arc.

One aspect of the technology is directed to a device comprising a housing, at least one microphone, and a conductive layer between the housing and the at least one microphone, the conductive layer including a conductive opening and one or more protrusions extending radially inward towards a center of the conductive opening.

The housing may include at least one microphone opening. The at least one microphone opening may be axially aligned with the at least one microphone opening. The conductive layer may include a conductive opening axially aligned with the at least one microphone opening. The device may further include a mesh extending across the at least one microphone opening.

The housing may be a plastic housing. The conductive layer may be copper. The conductive layer may be a printed circuit board. The one or more protrusions may be triangular protrusions such that a vertex of each of the triangular protrusions is closest to the center of the conductive opening.

The device may further comprise a printed circuit board between the conductive layer and the at least one microphone. The conductive layer may be a stiffener.

Another aspect of the technology generally relates to a conductive layer comprising one or more protrusions extending radially inwards towards a center of a conductive opening formed within the conductive layer, the one or more protrusions configured to attract an electrostatic discharge when the conductive layer is located within a non-conductive device housing.

The one or more protrusions may be triangular protrusions such that a vertex of each of the triangular protrusions is closest to the center of the conductive opening. The conductive layer may be between the non-conductive device housing and at least one microphone. The conductive opening may be axially aligned with a component opening in the housing. The component opening in the housing may be a microphone opening. The microphone opening may be axially aligned with the conductive opening.

The conductive layer may be an outermost layer of a printed circuit board. The conductive layer may be a stiffener.

### BRIEF DESCRIPTION OF THE DRAWINGS

FIG. 1A is a cross-sectional view of an example stack of components within a housing according to aspects of the disclosure.

FIG. 1B is a cross-sectional view of another example stack of components within a housing according to aspects of the disclosure.

FIG. 2 is a top view of a microphone opening in a housing according to aspects of the disclosure.

FIG. 3A is the example stack of components of FIG. 1A with an electrostatic discharge arc according to aspects of the disclosure.

FIG. 3B is the top view of a microphone opening of FIG. 2 with an electrostatic discharge arc according to aspects of the disclosure.

### DETAILED DESCRIPTION

The technology generally relates to a device including a conductive ground having one or more protrusions to attract electrostatic discharge (“ESD”). A buildup of ESD may cause an ESD arc which can damage sensitive components within the device. For example, an ESD arc may cause a hole to form in the diaphragm. Additionally or alternatively, an ESD arc may cause the diaphragm of the microphone to shatter, and/or damage an ESD sensitive sensor that is exposed by a hole in the housing. The conducive ground may attract the ESD arc away from the sensitive components. According to some examples, the ESD arc may be attracted to an electrostatic buildup at an apex of the protrusions. The ESD arc may, in some examples, strike the protrusion and be grounded by the conductive ground.

The device may be any device, such as a smartphone, tablet, hub, earbuds, AR/VR headset, etc. The device may include one or more microphones. The housing of the device may define a cavity adapted to hold a plurality of components, such as the one or more microphones. The housing may have one or more openings corresponding to each of the one or more microphones. For example, the housing may have an opening that corresponds, or substantially corresponds to, the shape and/or size of the microphone capsule and/or microphone diaphragm. In some examples, the microphone capsule and/or diaphragm may be square, circular, oblong, rectangular, rounded, etc. and the corresponding microphone opening in the housing may be a similar shape. Additionally or alternatively, the microphone capsule and/or diaphragm may have a different shape than the corresponding microphone opening. According to some examples, the microphone capsule and/or diaphragm may be axially aligned with the microphone openings. For example, the microphone capsule and/or diaphragm may have a center point and the microphone opening may have a center point. The center point of the microphone capsule and/or diaphragm may be axially aligned with the center point of the microphone opening. Additionally or alternatively, the microphone capsule and/or diaphragm may be located on a first plane transverse to the axis and the microphone opening may be on a second plane transverse to the axis. In some examples, the first plane and the second plane may be parallel.

The conductive ground may be between the microphone and the housing. According to some examples, the conductive ground may be copper. Additionally or alternatively, the conductive ground may be a conductive layer of a printed circuit board (“PCB”) or a flexible PCB. The conductive ground may have an opening corresponding to the microphone opening in the housing. For example, if the microphone opening is rectangular, the opening of the conductive ground may also be rectangular. In examples where the microphone opening is circular, the opening of the conductive ground may also be circular. However, the microphone and opening of the conductive ground may be different shapes.

The conductive ground may include one or more protrusions extending towards the center of the conductive opening. For example, the one or more protrusions may have a triangular shape such that an apex of each protrusion is closest to the center of the conductive opening relative to other portions of the conductive ground. In some examples, the protrusions may have a polygonal shape, such that there are multiple apexes extending towards the center of the conductive opening. According to some examples, ESD may be attracted to sharp corners, such as an apex, as electrostatic charge may accumulate at the corners and/or apex. In such an example, it is likely the ESD arc will strike a corner and/or apex of the protrusion.

According to some examples, the protrusions may be spaced apart equally around the perimeter of the conductive opening. Additionally or alternatively, there may be any number of protrusions, such as one, three, four, six, ten, thirteen, etc. The size, shape, and number of protrusions may be determined based on the size and shape of the microphone opening. For example, a larger microphone opening may result in a larger number of protrusions and/or larger protrusions as compared to a smaller microphone opening.

The apex of each of the one or more protrusions may be more effective at capturing ESD as compared to a smooth surface. For example, the conductive ground having one or more protrusions may be more effective at capturing ESD as compared to a conductive ground with a single smooth edge defining the conductive opening. Capturing the ESD may protect the microphone from being damaged by an ESD arc. Additionally or alternatively, capturing the ESD may protect sensitive components within the device.

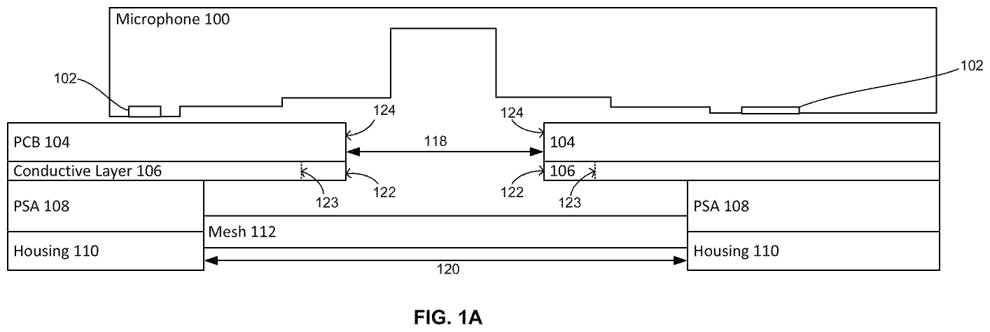

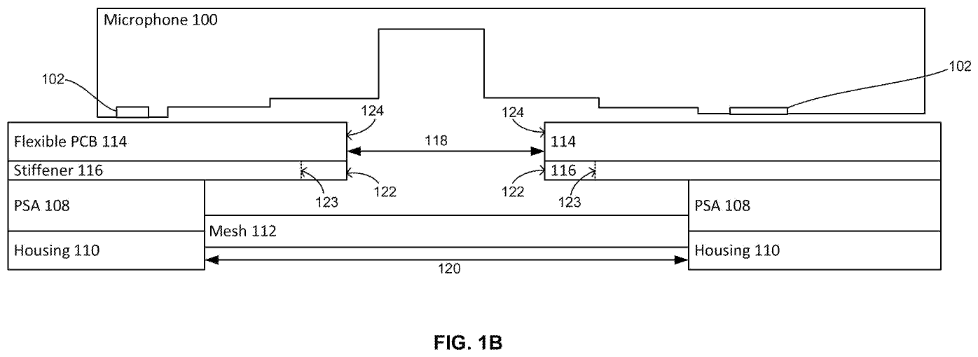

FIG. 1A illustrates a cross-section of a plurality of components within a housing of a device. The device may be, for example, a smart phone, laptop, hub, tablet, gaming console, home assistant device, earbuds, smartwatches, headsets, other wearable electronics, etc. The device may include a housing 110. The housing may have a cavity for holding the plurality of components. The plurality of components may include, for example, a microphone 100, ground pad of the microphone 102, PCB 104, conductive layer 106, pressure sensitive adhesive (“PSA”) 108, and mesh 112. The device may include other electronic components, such as one or more processors, memory, data, instructions, etc., within housing 110. Each component may be positioned within its own plane, although some components may be positioned, fully or partially, in the same plane as other components. While the stack of components is shown as horizontal and parallel to housing 110, the stack does not have to be horizontal as some components may have bends or curves to fit within housing 110. Additionally or alternatively, some components may overlap. Thus, the configuration of components, as shown, is merely an example and is not intended to be limiting.

Housing 110 may be formed from plastic or a non-conductive material. The housing 110 may include one or more openings. For example, housing 110 may include a microphone opening 120. In some examples, housing 110 may include openings for speakers, charging ports, etc. The microphone opening 120 may be of any shape and/or size, such as rectangular, square, circular, etc.

The microphone opening 120 may be covered with a material, such a mesh 112. The mesh 112 may be made of a conductive material and/or a non-conductive material. For example, the mesh 112 may be made of plastic, metal, cloth, or other materials. According to some examples, when mesh 112 is made of a conductive material, such as metal, the mesh 112 may be connected to a ground of the device. Additionally or alternatively, when mesh 112 is made of a conductive material, mesh 112 may not be connected to the device ground and, instead, may be connected to house 110. Mesh 112 may prevent debris from reaching and/or damaging microphone 100. According to some examples, mesh 112 may allow an ESD arc to pass through.

Within housing 110 may be a PCB 104. The PCB 104 may include a conductive ground, such as conductive layer 106. According to some examples, the conductive layer 106 may be a layer of PCB 104. For example, conductive layer 106 may be the outermost layer of PCB 104. Additionally or alternatively, conductive layer 106 may be a separate layer. Conductive layer 106 may be a conductive metal, such as copper, aluminum, silver, gold, etc. The conductive layer 106 may be located between the PCB 104 and housing 110. For example, conductive layer 106 may be closer to housing 110 as compared to the PCB 104.

Conductive layer 106 may include one or more protrusions. The protrusions may extend radially inward towards the center of conductive opening 118. The protrusions may be any shape or size having a vertex. For example, protrusions may be triangular, rectangular, polygonal, etc. At least one vertex of the protrusions may extend toward the center of conductive opening 118. In examples where the protrusions are rectangular, at least two of the vertexes may extend towards the center of the conductive opening 118. As the protrusions are made of conductive material, protrusions may attract an ESD arc, thereby preventing the ESD arc from striking and/or damaging the microphone.

According to some examples, conductive layer 106 may be connected to a ground that dissipates the ESD from the ESD arc such that the ESD arc does not cause damage to any of the components within the device, such as microphone 100. Additionally or alternatively, conductive layer 106 may be a grounding layer such that conductive layer 106 dissipates the ESD such that the ESD strike does not cause damage to any of the components within the device.

Conductive layer 106 may be bonded to housing 110 via PSA 108. As shown, PSA 108 is between conductive layer 106 and housing 110. When pressure is applied to PSA 108, the adhesive properties of PSA 108 may be activated. The adhesive properties of PSA 108 may bond and/or attach conductive layer 106 and housing 110. While PSA 108 is shown as coupling conductive layer and housing 110, any adhesive may be used to bond and/or attach conductive layer 106 and housing 110. For example a UV and/or heat activated adhesive may be used to bond and/or attach conductive layer 106 and housing 110. Thus, PSA 108 is only one example of what can be used to bond and/or attach conductive layer 106 and housing 110 and, therefore, is not intended to be limiting

Conductive opening 118 may be defined by edges 124 of PCB 104 and/or edges 122 of conductive layer 106. According to some examples, conductive opening 118 may be axially aligned with microphone opening 120. For example, a center of conductive opening 118 may be on the same axis as a center of microphone opening 120. Additionally or alternatively, conductive opening 118, microphone opening 120, and/or microphone 100 may be axially aligned. While edge 122 of conductive layer 106 is shown as aligning with edge 124 of PCB 104, the edge 123 of the conductive layer 106 may be offset and/or recessed from edge 124 of PCB. Thus, edge 122 aligning with edge 124 is merely one example and is not intended to be limiting.

The device may include a microphone 100 and ground pad 102. The ground pad 102 may be connected to microphone 100 and PCB 104. Microphone 100 may include a diaphragm, which may be easily damaged by an ESD strike. Protrusions may attract the ESD strike to prevent the ESD strike from reaching the microphone 100.

FIG. 1B illustrates a cross-section of a plurality of components within a housing of a device. The device and components may be similar to those discussed above in conjunction with FIG. 1A. The difference between the device in FIG. 1A and FIG. 1B is that the device of FIG. 1A may include a rigid PCB 104 and conductive later 106 whereas the device of FIG. 1B may include a flexible PCB 114 and a stiffener 116. A rigid PCB 104 may have the stability to keep the components level whereas a flexible PCB 114 may rely on stiffener 116 to provide stability to keep the components level.

According to some examples, flexible PCB 114 may include a conductive layer, similar to conductive layer 106 described above with respect to FIG. 1A. For example, an outermost layer of flexible PCB 114 may be a conductive layer. The conductive layer may be a conductive metal, such as copper, aluminum, silver, gold, etc. In examples where the conductive layer is the outermost layer of flexible PCB 114, the conductive layer may be located between flexible PCB 114 and stiffener 116. The conductive layer may include one or more protrusions extending radially inward towards the center of conductive opening 118.

In some examples, the conductive layer may be stiffener 116. For example, stiffener 116 may keep one or more components within housing 110 level when the device includes flexible PCB 114. Stiffener 116 may be a conductive metal, such as copper, aluminum, silver, gold, etc. In examples where stiffener 116 is the conductive layer, stiffener 116 may include one or more protrusions extending radially inward towards the center of conductive opening 118.

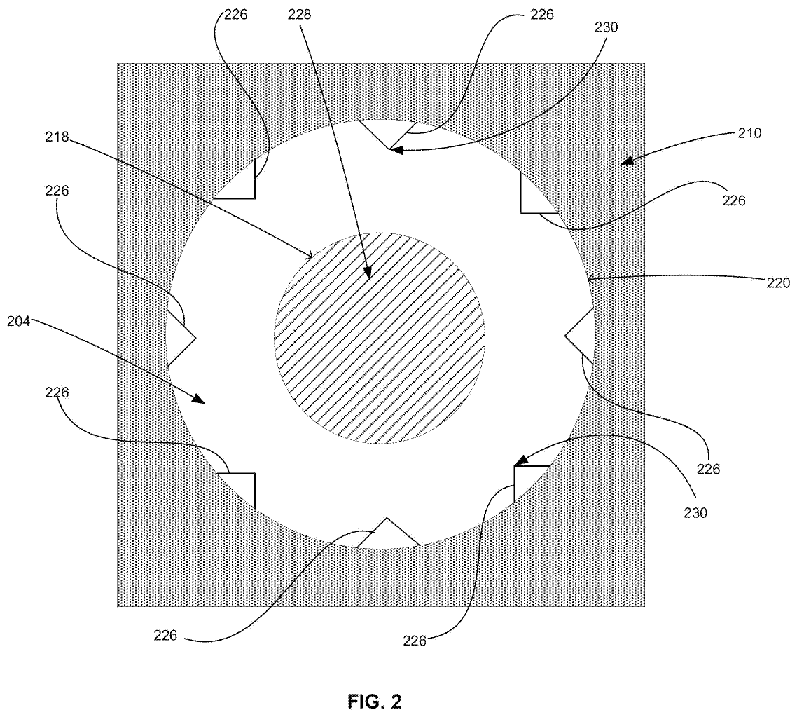

FIG. 2 illustrates layers of components within housing 210 when looking at microphone opening 220 from outside of housing 210 towards the inside of the device. For example, housing 210 may be the outermost layer of the device. The next outermost layer shown in FIG. 2 is the conductive layer may be in the form of protrusions 226. The next outermost layer is PCB 204. PCB 204 may be a rigid PCB or a flexible PCB. In examples where PCB 204 is a flexible PCB, a stiffener may be layered between PCB 204 and housing 210. The next outermost layer shown in FIG. 2 is diaphragm 228. Diaphragm 228 may be part of microphone 100. While only the layers of housing 210, protrusions 226, PCB 204, and diaphragm 228 are shown in FIG. 2, there may be additional layers from one or more components, such as those described with respect to FIGS. 1A and 1B. Additionally or alternatively, while the layers of components are described above and herein in a specific order, the order of the components in the stack may be in any order. Accordingly, the number of layers shown and the order of layers are merely exemplary and are not intended to be limiting.

There may be one or more openings in housing 210 for various components. For example, there may be a microphone opening 220, a speaker opening, a charging port opening, etc. Microphone 100 may be coaxial with microphone opening 220. For example, a center of microphone 100 may be axially aligned with the center of microphone opening 220. Microphone opening 220 may be any shape and size. For example, microphone opening 220 may be circular, oblong, rectangular, polygonal, etc. Thus, while microphone opening 220 is shown as being circular, it is merely exemplary and is not intended to be limiting.

Microphone 100 may include a diaphragm 228. Diaphragm 228 may be vulnerable to damage due to an ESD strike at or near microphone opening 220. In some examples, to prevent an ESD strike from reaching microphone 100, the device may include a conductive layer. The conductive layer may include one or more protrusions 226. The protrusions 226 may extend radially inward towards the center of microphone opening 220 and/or conductive opening 218. The protrusions 226 may be part of conductive layer 106 and/or stiffener 116, as discussed above with respect to FIGS. 1A and 1B. In a cross-sectional view of the device, the vertex 230 of protrusions 226 may correspond to edge 122 and/or edge 123 in FIGS. 1A and 1B.

Protrusions 226 may be any shape or size. As shown, protrusions 226 are triangular with a vertex extending radially inward toward the center of conductive opening 218. The sharp edge, or vertex 230, of the protrusion 226 may attract an ESD strike as electrostatic charge may accumulate at the vertex. For example, the charges that are distributed on the conductive layer may move around such that the electrostatic forces among the charges are balanced. Balancing the electrostatic forces when there are vertexes may push the charges into the vertices, causing the charges to accumulate at the vertex. The ESD strike may, therefore, be attracted to the vertex of protrusion 226. According to some examples, a vertex of protrusion 226 may be more effective as capturing ESD as compared to a smooth surface, such as a conductive layer that has a circular opening with no protrusions. Capturing the ESD arc via the protrusions 226 may protect diaphragm 228 and, therefore, the microphone, from being damaged by an ESD arc. Additionally or alternatively, capturing the ESD arc via the protrusions 226 may protect sensitive components within the device.

According to some examples, protrusions 226 may be equally spaced around the perimeter of conductive opening 218. As shown, there are eight (8) protrusions 226 equally spaced around the perimeter of conductive opening 218. However, there may be any number of protrusions and/or the protrusions 226 may be located randomly around the perimeter of conductive opening 218. For example, more protrusions 226 may be placed along a first portion of the perimeter of conductive opening as compared to a second portion. According to some examples, more protrusions 226 may be placed along a first portion of the perimeter where the first portion of the perimeter is the farthest from sensitive components within the housing. This may attract the ESD arc to a location farthest from sensitive components and, thereby, provide better protection from an ESD arc for those sensitive components.

The size, shape, and/or number of protrusions may be determined based on the size and shape of the microphone opening. In some examples, a larger microphone opening 220 may result in a larger number of protrusions 226 and/or larger protrusions 226 as compared to a smaller microphone opening 220. According to some examples, the shape of protrusions 226 may have more than one vertex depending on the type of device and/or number of sensitive components near conductive opening 218.

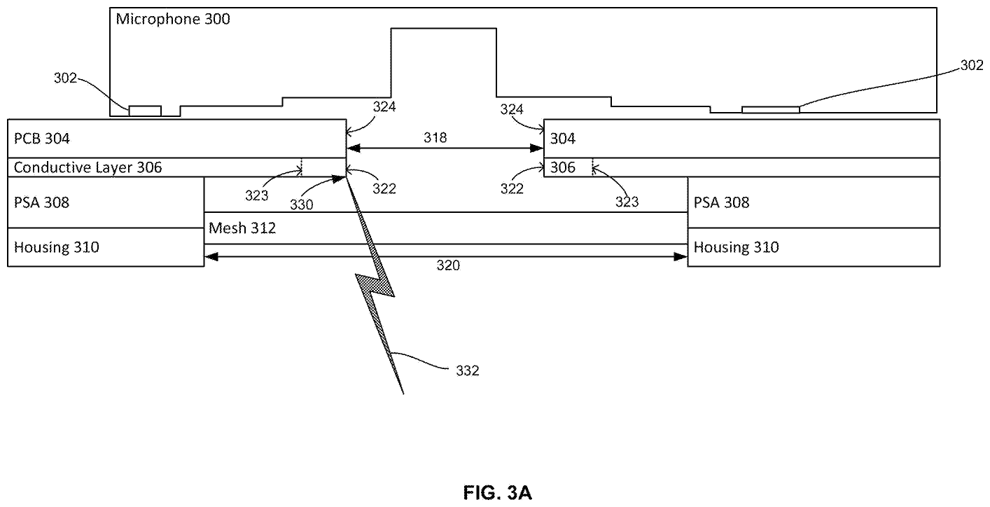

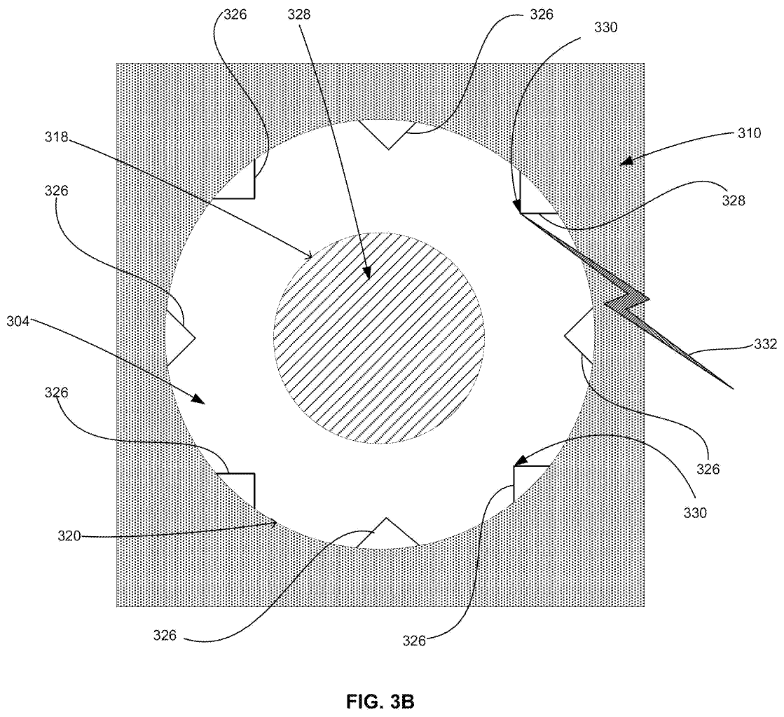

FIGS. 3A and 3B illustrate an ESD arc captured by a protrusion. The ESD arc may come from outside the housing, or casing, of the device. The ESD arc may go through one or more component holes in the housing. For example, an ESD arc may enter the microphone opening and strike a component within the housing. Having sharp protrusions, or protrusions with one or more vertexes, the protrusions may attract ESD, therefore, capture the ESD arc before the ESD arc can strike a sensitive component within the housing.

FIG. 3A illustrates a cross-section of a device. The device and components of FIG. 3A may be similar to those discussed above in conjunction with FIGS. 1A and 1B. For example, the device shown in FIG. 3A may include a microphone 300, GND pad 302, PCB 304, conductive layer 306, PSA 308, housing 310, and mesh 312. A microphone opening 320 may be formed in housing 310. A conductive opening 318 may be formed in PCB 304 and/or conductive layer 306. According to some examples, conductive opening 318 may be defined by edge 324 of PCB 304 and/or edge 322 of conductive layer 306.

As shown in FIG. 3A, an ESD arc 332 may be attracted to a vertex 330 of a protrusion of conductive layer 306. For example, vertex 330 of the protrusion may have be a sharp point, such as an apex of a triangle. The vertex 330 may have a buildup of electrostatic charge which attracts the ESD arc 332. Having the ESD arc 332 strike vertex 330 of the protrusion may protect sensitive components within housing 310 from damage caused by ESD arc 322.

FIG. 3B illustrates a view of the device when looking into the device from the outside of the housing. For example, the components within housing may be layered. Of the components shown, the diaphragm 328 of the microphone may be the innermost layer. Working towards the outermost housing, the next layer may be a PCB 304. The PCB 304 may be a flexible PCB or a rigid PCB. In examples where PCB 304 is a flexible PCB, the device may additionally include a stiffener. The PCB 304 may define a conductive opening 318. According to some examples, the shape of the conductive opening 318 may correspond to the shape of microphone opening 320. Additionally or alternatively, the conductive opening 318 may be axially aligned with microphone opening 320.

The next layer may be a conductive layer. In some examples, the conductive layer may be a layer of PCB 304. For example, the conductive layer may be the layer of PCB 304 that is closest to housing 310. Additionally or alternatively, the conductive layer may be a separate layer. In examples where PCB 304 is a flexible PCB, the stiffener may be the conductive layer. In another example where the PCB 304 is a flexible PCB, the conductive layer may be a separate layer from the PCB 304 and/or the stiffener.

The conductive layer may include one or more protrusions 326. There may be any number of protrusions in any shape and/or size. The protrusions 326 may include a vertex 330, or apex. The vertex 330 may be a sharp point that attracts an ESD arc. The protrusions 326 may extend radially inward toward the center of conductive opening 318. Thus, as an ESD arc 332 goes through microphone opening 320, the ESD arc 332 may strike protrusions 326 rather than striking any of the sensitive components within housing 310, such as microphone diaphragm 328.

The outermost layer of the device may be housing 310. Housing 310 may be formed of a non-conductive material, such as plastic, rubber, glass, ceramic, etc. Housing 310 may include an opening for one or more components. For example, housing 310 may include a microphone opening 320. Microphone opening 320 may be axially aligned with a microphone within the device. For example, a center of the microphone may be on the same axis as the center of microphone opening 320.

As shown in FIG. 3B, and as discussed with FIG. 3A, protrusions 326 may be configured to attract an ESD arc 332. For example, the ESD arc may be attracted to a vertex 330 of protrusions 326. The ESD arc 332 may strike protrusion 326 instead of striking diaphragm 326, thereby preventing damage to diaphragm 326 and/or any other sensitive components within housing 310. For example, conductive layer, including protrusions 326, may be a ground layer. As a ground layer, conductive layer may dissipate the electrostatic charge to prevent damage by an ESD arc 332 to any of the sensitive components. According to some examples, the conductive layer may be connected to the system ground, or the ground of the device. After the ESD arc 322 strikes protrusion 326, the charge from ESD arc 322 may dissipate as it is dispersed on the system ground and/or be capacitively transferred to another ground or object.

According to some examples, the conductive layer with protrusions extending radially inwards towards a center of a conductive opening in the conductive layer may be used within any device that has a non-conductive housing. The protrusions of the conductive layer may attract an ESD arc to prevent the ESD arc from striking one or more sensitive components. While a microphone was discussed above as an example of a sensitive component, the sensitive component may be any component within the device subject to damage from an ESD arc. For example, a sensitive component may be one or more sensors that are sensitive to ESD and that are exposed by a hole in the housing. The sharp edges and/or points on the protrusions, such as an apex for a triangular shape, or vertex for a polygonal shape, may have a buildup of electrostatic charge that attracts the ESD arc. By attracting the ESD arc to the sharp edges and/or points on the protrusion, the ESD arc may be redirected to the conductive layer instead of striking a sensitive component within the device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A device, comprising:
a housing,
at least one microphone; and
a conductive layer between the housing and the at least one microphone, the conductive layer including a conductive opening and one or more protrusions extending radially inward towards a center of the conductive opening.

2. The device of claim 1, wherein the housing includes at least one microphone opening.

3. The device of claim 2, wherein the at least one microphone is axially aligned with the at least one microphone opening.

4. The device of claim 2, wherein the conductive layer includes a conductive opening axially aligned with the at least one microphone opening.

5. The device of claim 2, further comprising a mesh extending across the at least one microphone opening.

6. The device of claim 1, wherein the housing is a plastic housing.

7. The device of claim 1, wherein the conductive layer is copper.

8. The device of claim 1, wherein the conductive layer is a printed circuit board.

9. The device of claim 1, wherein the one or more protrusions are triangular protrusions such that a vertex of each of the triangular protrusions is closest to the center of the conductive opening.

10. The device of claim 1, further comprising a printed circuit board between the conductive layer and the at least one microphone.

11. The device of claim 10, wherein the conductive layer is a stiffener.

12. A conductive layer, comprising:
one or more protrusions extending radially inwards towards a center of a conductive opening formed within the conductive layer, the one or more protrusions configured to attract an electrostatic discharge when the conductive layer is located within a non-conductive device housing.

13. The conductive layer of claim 12, wherein the one or more protrusions are triangular protrusions such that a vertex of each of the triangular protrusions is closest to the center of the conductive opening.

14. The conductive layer of claim 12, wherein the conductive layer is between the non-conductive device housing and at least one microphone.

15. The conductive layer of claim 12, wherein the conductive opening is axially aligned with a component opening in the housing.

16. The conductive layer of claim 15, wherein the component opening in the housing is a microphone opening.

17. The conductive layer of claim 16, wherein the microphone opening is axially aligned with the conductive opening.

18. The conductive layer of claim 12, wherein the conductive layer is an outermost layer of a printed circuit board.

19. The conductive layer of claim 12, wherein the conductive layer is a stiffener.
